(19) United States
(12) Patent Application Publication
(10) Pub. No.: US 2018/0247193 A1
(43) Pub. Date: Aug. 30, 2018

(54) NEURAL NETWORK TRAINING USING COMPRESSED INPUTS

(71) Applicant: Xtract Technologies Inc., Vancouver (CA)

(72) Inventor: Elliot Mark Holtham, Vancouver (CA)

(21) Appl. No.: 15/903,353

(22) Filed: Feb. 23, 2018

Related U.S. Application Data
(60) Provisional application No. 62/463,299, filed on Feb. 24, 2017.
(60) Provisional application No. 62/527,658, filed on Jun. 30, 2017.
(60) Provisional application No. 62/539,931, filed on Aug. 1, 2017.

(51) Int. Cl. G06N 3/08; G06T 9/00; H04N 19/60

(52) U.S. Cl. CPC G06N 3/08; H04N 19/60; G06T 9/002

(57) ABSTRACT

Aspects relate to systems and methods for improving the operation of computer-implemented neural networks. Some aspects relate to training a neural network using a compressed representation of the inputs either through efficient discretization of the inputs, or choice of compression. This approach allows a multiscale approach where the input discretization is adaptively changed during the learning process, or the loss of the compression is changed during the training. Once a network has been trained, the approach allows for efficient predictions and classifications using compressed inputs. One approach can generate a larger more diverse training dataset based on both simulations from physical models, as well as incorporating domain expertise and other available information. One approach can automatically match the documents to the list, while still allowing a user to input information to update and correct the matching process.

### CROSS-REFERENCE TO RELATED APPLICATIONS

The present application claims the benefit under 35 U.S.C. § 119(e) of U.S. Provisional Patent Application No. 62/463,299, filed on Feb. 24, 2017, entitled “NEURAL NETWORK TRAINING USING COMPRESSED INPUTS,” U.S. Provisional Patent Application No. 62/527,658, filed on Jun. 30, 2017, entitled “MACHINE LEARNING SYSTEMS AND METHODS FOR DOCUMENT MATCHING,” and U.S. Provisional Patent Application No. 62/539,931, filed on Aug. 1, 2017, entitled “MACHINE LEARNING SYSTEMS AND METHODS FOR DATA AUGMENTATION,” the contents of which are hereby incorporated by reference herein in their entirety.

### TECHNICAL FIELD

The present disclosure relates to machine learning. More particularly, the present disclosure is in the technical field of training, optimizing and predicting using neural networks.

### BACKGROUND

The topic of designing and using neural networks and other machine learning algorithms has seen significant attention over the last several years because of the tremendous results associated with these networks. Artificial neural networks are artificial in the sense that they are computational entities, inspired by biological neural networks but modified for implementation by computing devices. A neural network typically comprises an input layer, one or more hidden layers and an output layer. The nodes in each layer connect to nodes in the subsequent layer and the strengths of these connections are typically learnt from data during the training process.

### SUMMARY OF THE DISCLOSURE

The accuracy of machine learning predictions is highly dependent on the quality and variety of data within a training dataset. For example, a neural network can be trained using training data that includes input data and the correct or preferred output of the model for the corresponding input data. The neural network can repeatedly process the input data, and the parameters (e.g., the weight matrices of the node connection strengths) of the neural network can be modified in what amounts to a trial-and-error process until the model produces (or “converges on”) the correct or preferred output. The modification of weight values may be performed through a process referred to as “backpropagation.” Backpropagation includes determining the difference between the expected model output and the obtained model output, and then determining how to modify the values of some or all parameters of the model to reduce the difference between the expected model output and the obtained model output.

In some implementations, when training and optimizing network parameters, as well as performing forward propagation predictions, it would be desirable to work with compressed file types because not only are the inputs often stored in this format, but because the media storage is often more efficient than with uncompressed storage. Current machine learning techniques do not ordinarily accept compressed inputs to the network. Some aspects of the present disclosure relate to a system and associated methods for training, and predicting with, neural networks using compressed inputs. This approach allows much smaller files to be used, and is more computationally efficient, thus potentially saving time and/or requiring less powerful computational resources such as mobile phones or laptop computers. The approach also allows different resolutions and scales of the inputs to be used during the training process, which may not only speed up the training process, but also improve the optimization convergence during training (and possibly help avoid local minimum).

To achieve robust results, it may be desirable that the training inputs represent the same level of variability (or as much as possible) as the inputs that will be provided to the network during use. For machine learning applications, it may be desirable to add additional generated or simulated data to the naturally available dataset to help the training process and improve prediction accuracy. For example, when training neural networks and other machine learning algorithms, it can be desirable to have as much representative training data as possible with which to train the machine learning system. Unfortunately, for many applications sufficient data does not exist or is hard and/or expensive to obtain. Thus, a network trained using only a small sample of a large data population may not produce accurate predictions using new inputs from the population that were not used during training.

Some aspects of the present disclosure relate to a system and associated methods for generating or augmenting machine learning training data using numerical simulations. The numerical simulations can be based on an understanding of the physical model associated with the machine learning problem (such as Navier-Stokes equation, Maxwell's equation, wave equation, diffusion equation, advection equation, Black-Scholes etc.). Some of the disclosed systems and methods may increase prediction accuracy and be used to augment and balance the dataset, particularly for machine learning tasks with very unbalanced datasets (many of one class and few of another etc.).

Other aspects of the disclosure relate to machine learning techniques for document matching. The topic of matching or grouping individual documents or files based on a list or similar information is a common task in many commercial applications. Ensuring that the documents are matched correctly and quickly is of high priority as is the ability for a user to examine and verify that the files and/or documents have been matched correctly. As the number of documents or files to be matched with the master list grows, the task becomes more complex and less accurate for both humans and software techniques.

When matching documents to a list, it can be desirable to have an automated method that requires little to no human correction and intervention. Additionally, it can be desirable to enable a human user to verify and modify the automated matched results. A system and associated methods are disclosed for training and using a machine learning model for matching documents and/or files to a list of documents and/or files. The disclosed system and methods provide a robust and easily automatable approach which allows a user to quickly verify the accuracy of the results.

### BRIEF DESCRIPTION OF THE DRAWINGS

FIG. 1 is a block diagram showing the primary components, inputs and outputs of one embodiment of a system according to one embodiment.

FIG. 2 is a flow chart of the embodiment of FIG. 1 illustrating a multiscale approach to train the network on successively less lossy compressed inputs.

FIG. 3 is a block diagram showing the primary components, inputs and outputs of another embodiment of the system of FIG. 1 using an adaptive mesh representation.

FIG. 4 is a flow chart illustrating the operation of the embodiment of FIG. 3.

FIG. 5 is a simple diagram showing how a regular pixelated 21) image can be compressed through adaptive mesh refinement. The process can be performed as a single step (bottom), or as part of a multistep, multiscale process (top).

FIG. 6 is a flow diagram of an embodiment of a process of using a previously trained network and using the network to perform predictions on compressed inputs.

FIG. 7 is a presently preferred embodiment of the hardware for optimizing, training and predicting using the neural network according to FIGS. 1-6.

FIG. 8 is a block diagram showing software modules, inputs and outputs of one embodiment of a system for generating or augmenting machine learning training data using numerical simulations.

FIG. 9 is a block diagram showing software modules, inputs and outputs of the simulate data module block 810 of FIG. 8.

FIG. 10 is a block diagram depicting an example of the hardware for augmenting the data inputs in the system of FIGS. 8 and 9.

FIG. 11 is a block diagram showing software modules, inputs, and outputs of one embodiment of a system for matching documents.

FIG. 12 is a block diagram showing modules, inputs, and outputs of one embodiment of the matching portion of the system of FIG. 11.

FIG. 13 is a presently preferred embodiment of the hardware for performing the task of matching documents and or files to the list in the system of FIGS. 11 and 12.

### DETAILED DESCRIPTION OF PREFERRED EMBODIMENTS

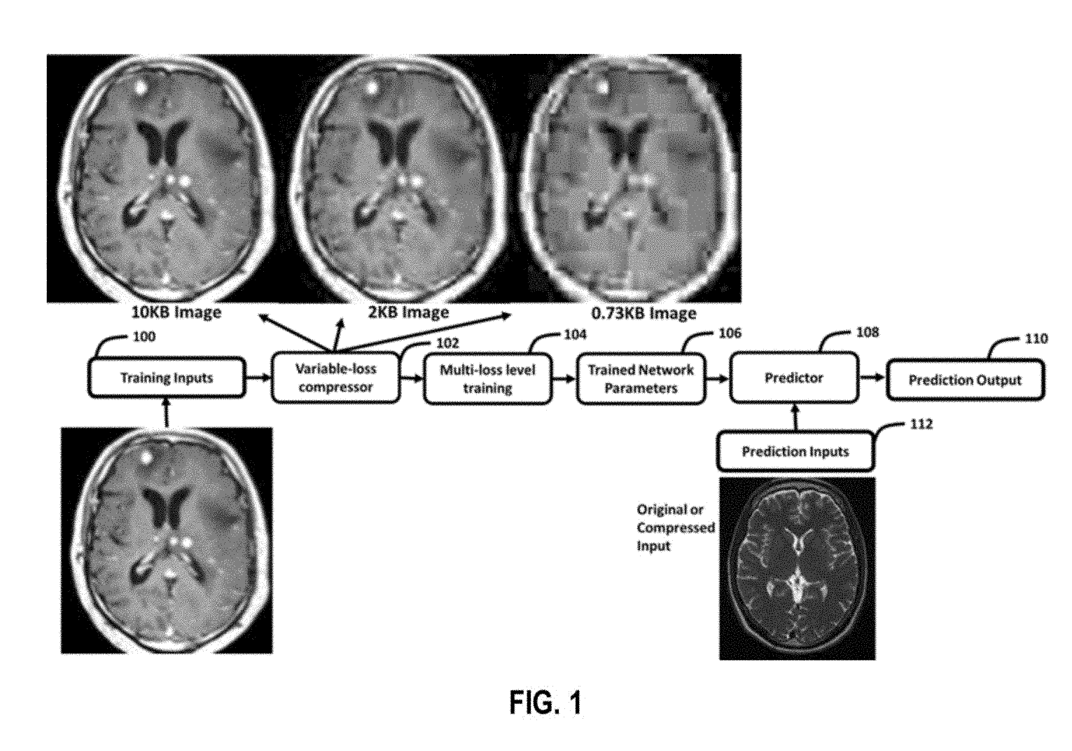

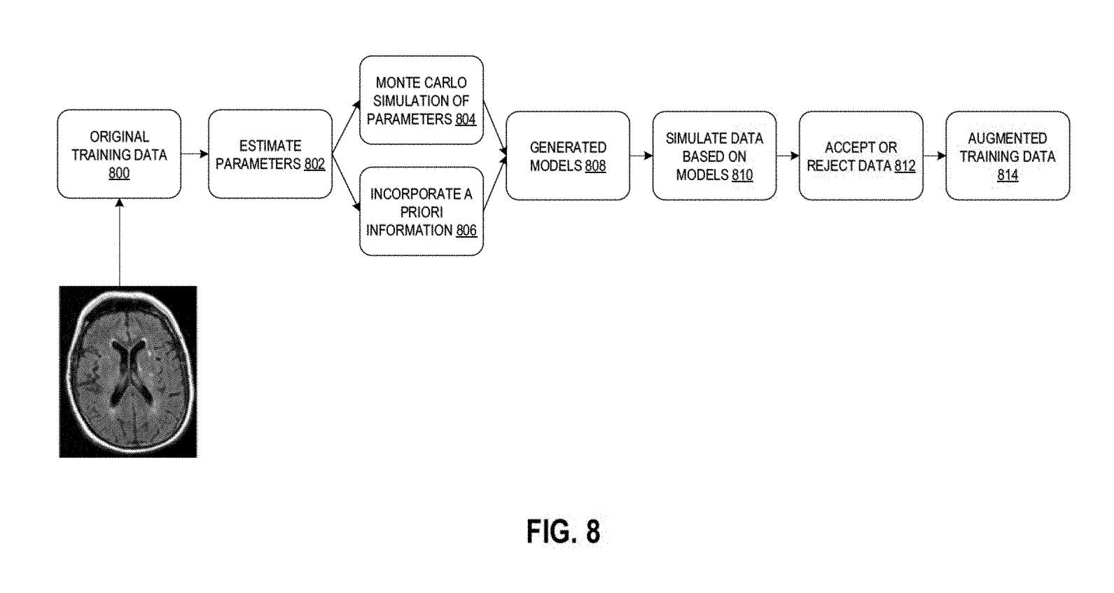

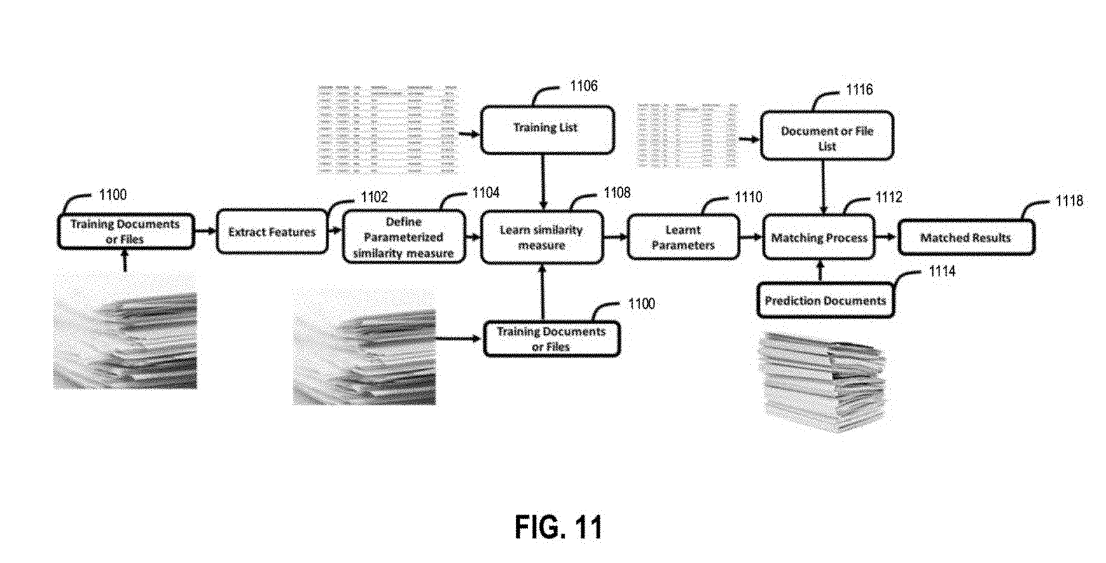

Various inventive systems and methods (generally “features”) that improve the operation of computer-implemented neural networks will now be described with reference to the specific embodiments shown in the drawings. More specifically, features for training neural networks using compressed inputs will initially be described with reference to FIGS. 1-7. These compressed-input training techniques can improve the performance of neural networks on compressed images, and can yield trained neural networks that operate more effectively on compressed images than similar neural networks trained using full-resolution image data. Another benefit of these features is that they reduce the computational resources used to train a neural network to a desired level of accuracy compared to techniques that use full-resolution image data during training. Features for augmenting training data sets will then be described with reference to FIGS. 8-10. Beneficially, these features can reduce the amount of real-world training data required to train a machine learning model to achieve a desired level of accuracy. Finally, features for matching documents or files using a neural network are described with reference to FIGS. 11-13. These features can produce machine learning models that are able to perform complex matching tasks, for example by matching documents with multiple features/fields to the corresponding item in a list. As will be recognized, these features may be used independently or in combination within a given computer-implemented neural network.

Artificial neural networks are used to model complex relationships between inputs and outputs or to find patterns in data, where the dependency between the inputs and the outputs cannot be easily ascertained. A neural network typically includes an input layer, one or more intermediate (“hidden”) layers, and an output layer, with each layer including a number of nodes. The number of nodes can vary between layers. A neural network is considered “deep” when it includes two or more hidden layers. The nodes in each layer connect to some or all nodes in the subsequent layer and the weights of these connections are typically learnt from data during the training process, for example through backpropagation in which the network parameters are tuned to produce expected outputs given corresponding inputs in labeled training data. During training, an artificial neural network can be exposed to pairs in its training data and can modify its parameters to be able to predict the output of a pair when provided with the input. Thus, an artificial neural network is an adaptive system that is configured to change its structure (e.g., the connection configuration and/or weights) based on information that flows through the network during training, and the weights of the hidden layers can be considered as an encoding of meaningful patterns in the data.

A convolutional neural network (“CNN”) is a type of artificial neural network that is commonly used for image analysis. Like the artificial neural network described above, a CNN is made up of nodes and has learnable weights. However, the nodes of a layer are only locally connected to a small region of the width and height layer before it (e.g., a 3×3 or 5×5 neighborhood of image pixels), called a receptive field. The hidden layer weights can take the form of a convolutional filter applied to the receptive field. In some implementations, the layers of a CNN can have nodes arranged in three dimensions: width, height, and depth. This corresponds to the array of pixel values in each image (e.g., the width and height) and to the number of images in a sequence or stack (e.g., the depth). A sequence can be a video, for example, while a stack can be a number of different channels (e.g., red, green, and blue channels of an image, or channels generated by a number of convolutional filters applied in a previous layer). The nodes in each convolutional layer of a CNN can share weights such that the convolutional filter of a given layer is replicated across the entire width and height of the input volume (e.g., across an entire frame), reducing the overall number of trainable weights and increasing applicability of the CNN to data sets outside of the training data. Values of a layer may be pooled to reduce the number of computations in a subsequent layer (e.g., values representing certain pixels, such as the maximum value within the receptive field, may be passed forward while others are discarded). Further along the depth of the CNN pool masks may reintroduce any discarded values to return the number of data points to the previous size. A number of layers, optionally with some being fully connected, can be stacked to form the CNN architecture. References herein to neural networks performing convolutions and/or pooling can be implemented as CNNs.

Although aspects of some embodiments described in the disclosure will focus, for the purpose of illustration, on particular examples of machine learning models, output predictions, and training data, the examples are illustrative only and are not intended to be limiting. Various aspects of the disclosure will now be described with regard to certain examples and embodiments, which are intended to illustrate but not limit the disclosure.

### Overview of Example Compressed Neural Network Inputs

A block diagram showing the primary functional components (which may be implemented as software modules), inputs and outputs of one embodiment of a system for using compressed inputs is shown in FIG. 1 (the block diagram uses brain MRI images to illustrate the key modules and components of the system). Training inputs 100 in either compressed or non-compressed format are input into the variable-loss compressor module 102. This module generates inputs of different compression levels which are input into the multi-loss training module 104 to generate the trained network parameters 106.

Once the network parameters have been determined, they can be used by predictor 108 to process either compressed (at any compression level) or non-compressed prediction inputs 112 to produce the output prediction results 110. Example applications include training on MRI or dermatology images to make medical diagnoses and predictions, and classifying content and tagging people from videos on social media or content-hosting web sites or applications. Other examples include categorizing images in photo collections, as well as speech and audio recognition tasks. Training inputs typically consist of datasets such as images, videos or audio files.

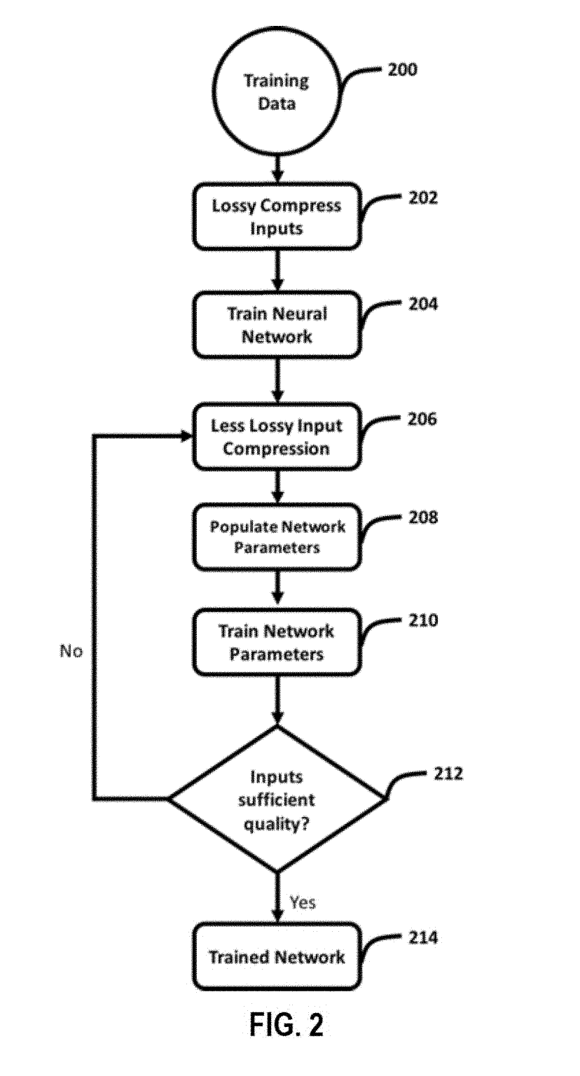

In one embodiment of the system, as shown in the flow chart in FIG. 2, these inputs 200 are first compressed using a compression algorithm (for example MPEG—1 Audio Layer—3 (MP3), JPEG, JPEG 2000, MPEG etc.) using only a few basis vectors to represent the input in a process 202 before the neural network parameters are trained in a process 204. Process 206 inputs less lossy compressed inputs (for example keeping more basis vectors) into the network where the network parameters are then populated in process 208 and then re-trained in process 210. Appropriate levels of compression loss may be selected (either manually or by the compressor module 102 or training module 110) or based on the quality and size of the inputs, the desired accuracy of the predictions, the convergence of the training, and the available computer resources for training and predicting. With each training iteration, a lower level of compression loss (and thus a higher image resolution) may be used.

The network parameters are updated during training using the previous iteration parameters as a starting point. If the current inputs are at the required or desired compression (decision point 212), the obtained optimized network parameters are the final parameters for the neural network 214. If the inputs are not at the final desired resolution (potential stopping criterion may include reaching the original input quality (no additional compression), or other metrics such as convergence rates or reaching a desired training or validation accuracy), the inputs are once again sampled at higher quality (less compression loss, for example keeping more basis vectors), and the process repeated until the final desired resolution is achieved. Various other workflows of cycling between representations and details of the inputs (for example low vs high frequency etc.) are also possible. The flowchart in FIG. 2 shows one embodiment of the current system of FIG. 1, but it is to be understood that the teachings herein can be modified using other parameter optimization approaches which are common in other applied mathematics fields. Each of the functional components 102, 104 and 108 in FIG. 2 may be implemented in executable code that runs on one or more computing devices, or may be implemented in application-specific circuitry (e.g., FPGAs or ASICs).

Since the computational cost of training and predicting is typically related to the resolution, size and representation of the inputs, training and predictions on more compressed inputs may require fewer numerical operations. The time required to train the network may be reduced if some of the training can be performed on more compressed or more efficiently represented inputs. It may be possible to learn approximate network parameters quickly using lossy or coarsely discretized inputs, before working with the high information content inputs. Furthermore, small scale features in the inputs may lead to local minima during the training optimization. Initially starting with lossy or coarser discretized inputs may eliminate some of the local minima, and make the optimization problem easier to solve.

In more detail consider, for example, the training of a neural network using image inputs that are originally stored in JPEG compression format (the same analysis is applicable to other input formats such as videos or audio files). Using compression, the image can be represented in a more efficient form than a regular pixelated image—in this JPEG compression, the image is represented as a weighted sum of a set of basis vectors. While for JPEG images the basis vectors are obtained using a discrete cosine transform, the image could be represented in almost any format such as using wavelet or curvelet compressions. Describing the Update Network Parameters 210 process shown in FIG. 2 in more detail, we first write our network model as

yₖ₊₁=F(yₖ,θₖ)

where, x is the data and y=[y₁^{T}, . . . yₙ^{T}]^{T} are the hidden layers, and θₖ={Kₖ,bₖ,s} are parameters to be determined by the “learning” process. A common choice when using neural networks with inputs that contain spatial information is to have the function F as a convolution with parameters θ that represents the convolution weights, bias and stencil, leading to the explicit expression

F(y,K(s),b)=σ_{α}(K(s)y+b)

where K(s) is a convolution matrix, that is a circular matrix that represents the stencil or convolution kernel, s, b is a bias vector and σ_{α} is a smooth activation function.

For simplicity, we have ignored the pooling layer, although it can be added in general. A classifier is obtained by propagating forward and using the last layer in some classification algorithm such as least squares, logistic regression or support vector machines. The classifier can be written as

z=g(W,yₙ)

where g is a classification function and W are classification weights. In supervised training, the predicted label z is compared to a known label and the different parameters, s, b and W are tuned by an optimization algorithm such that z is approximately the observed data for all known examples.

It has been shown that there are at least two ways to move between different spatial resolutions of inputs, a continuous differential approach and an algebraic multigrid approach. Both methods can easily be extended to work on non-uniform meshes and other input representations as is standard practice in these fields. For example, there are numerous papers on multigrid approaches on wavelet represented inputs and this approach can easily be extended to other basis vectors and non-structured grid representations. While this document describes two such methods for moving between different scales of inputs, other methods may also be used to train and predict using compressed inputs.

One embodiment is based on the continuous representation of the convolution operation. In previous work on the continuous approach, it was shown in 1D how the convolution s*y can be represented by differential operators, where

$$s * y \approx {α}_{1} y + {α}_{2} \frac{dy}{dx } + {α}_{3} \frac{{d}^{2} y}{{dx}^{2}} ,$$

and α₁, α₂, α₃ are new weights. The vector y is interpreted as a discretization (a grid function) of the function y(x). This can easily be extended to higher dimensions such as 2D and 3D. The connection between the convolution and differential operators allows working with inputs represented by most basis vectors and functions since computing derivatives on these vectors and functions is a known task. The connection also allows working with different sampling schemes and mesh representations of the inputs (for example semi or unstructured meshes), upon which it is well known how to calculate derivative operators.

Another embodiment is based the algebraic multigrid approach. Let yₕ be a discretization of an input on a fine mesh, h and let y_{H} be a discretization of the same input on a coarse mesh, H. Here,

y_{H}=Ryₕ and \tilde{y}ₕ=Py_{H}

where P is a prolongation matrix and R is a restriction matrix. That is, the coarse scale input is obtained using some linear transformation of the fine scale input (one example may include averaging) and that an approximate fine scale input can be obtained from the coarse scale input by interpolation. R and P could also depend on K. Using the prolongation and restriction we obtain that,

K_{H}y_{H}=RKₕPy_{H}.

This allows moving between different spatial scales of inputs (both fine to coarse and coarse to fine). Developing different restriction and prolongation operators for different grid structures (for example, regular, semi-structured, or fully unstructured) is a known task in the multigrid literature. These two methods allow moving between different scales and working with compressed inputs.

In another embodiment of the system, the inputs may also be represented more efficiently through different discretizations. For example, many images can be represented using more efficient representations than uniformly spaced rectangular pixels without a significant loss of information. Examples include using curved meshes, semi-structured representations such as quadtree and octree meshes, and fully unstructured meshes as commonly found in finite element methods allows for the efficient storage and representation of the inputs. This is particularly true of inputs that can be compressed in both space and time such as videos where a significant storage reduction may be possible with little loss of information. For the video example, the input does not need to be sampled uniformly in either space or time, and different regions of the video can be sampled adaptively in both space and time. Since the computational complexity of the convolution is related to numerical operations required, the computational cost of training the network parameters and making predictions may be reduced using more efficient storage schemes since fewer mathematical operations may be required.

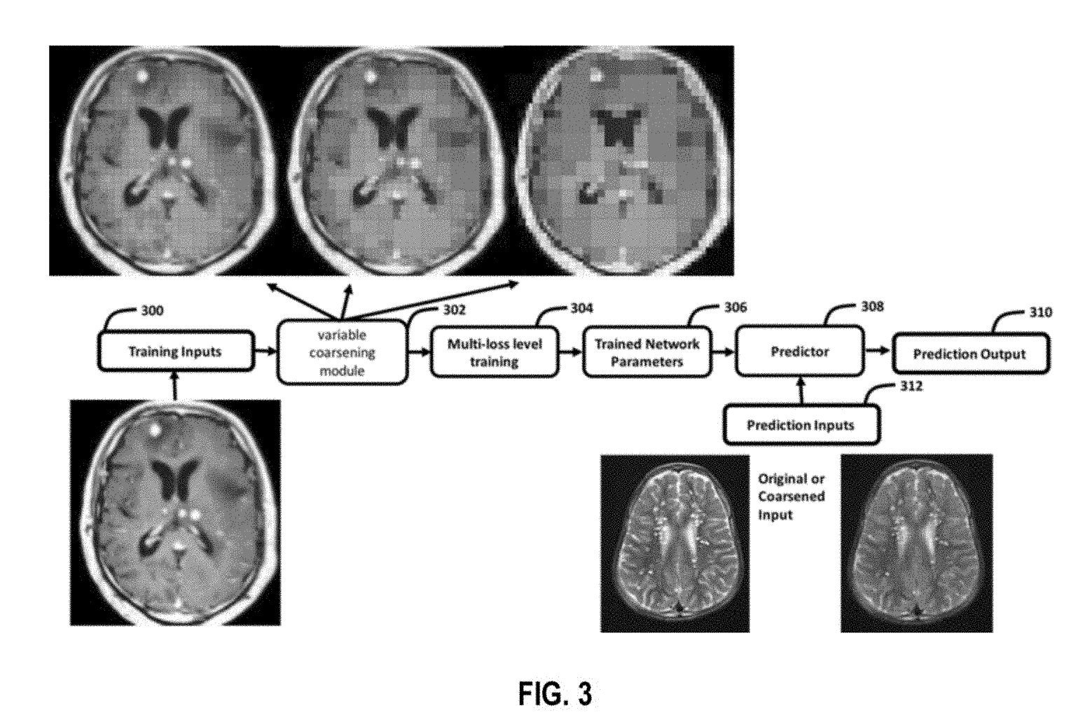

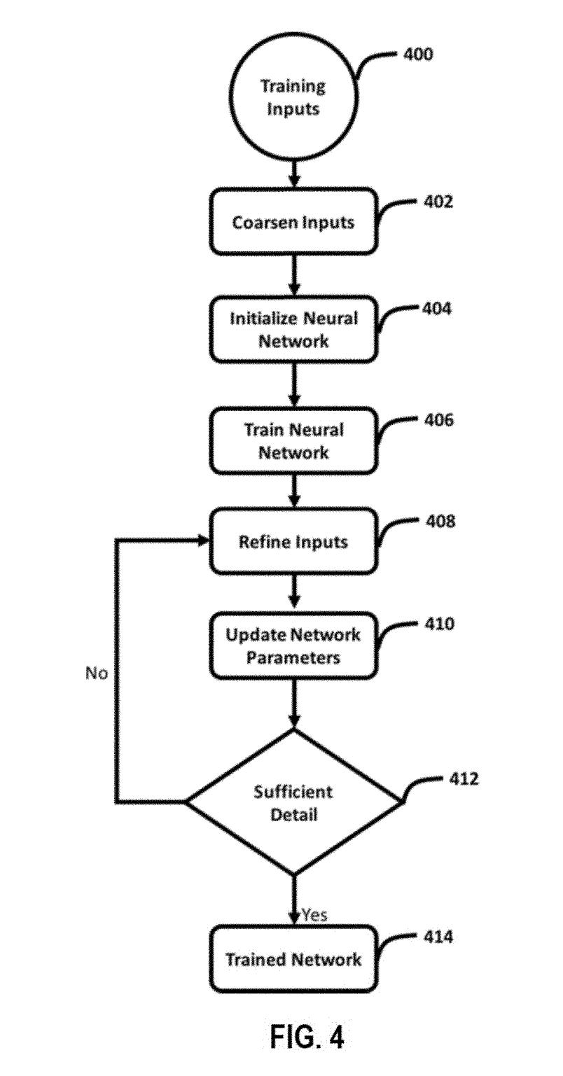

A block diagram showing the primary functional components (which may be implemented as software modules), inputs and outputs of this embodiment of the system is shown in FIG. 3. Training inputs 300 in either regular sampled or adaptively sampled format are input into the variable coarsening module 302. This module generates inputs of different levels of mesh refinements which are input into the multi-level training module 304 to recover the trained network parameters 306. Once the network parameters have been determined, prediction 308 can be performed on either regularly sampled inputs or adaptively sampled inputs 312 to produce the output predictions 310. Each of the functional components 302, 304 and 308 in FIG. 3 may be implemented in executable code that runs on one or more computing devices, or may be implemented in application-specific circuitry (e.g., FPGAs or ASICs). In this embodiment of the system shown in the flow chart in FIG. 4, training inputs 400 typically consist of datasets such as images, videos or audio files. In this embodiment of the system, these inputs are first sampled using adaptive meshing to represent the input in a process 402 before the neural network parameters are initialized (in process 404) and trained in a process 406.

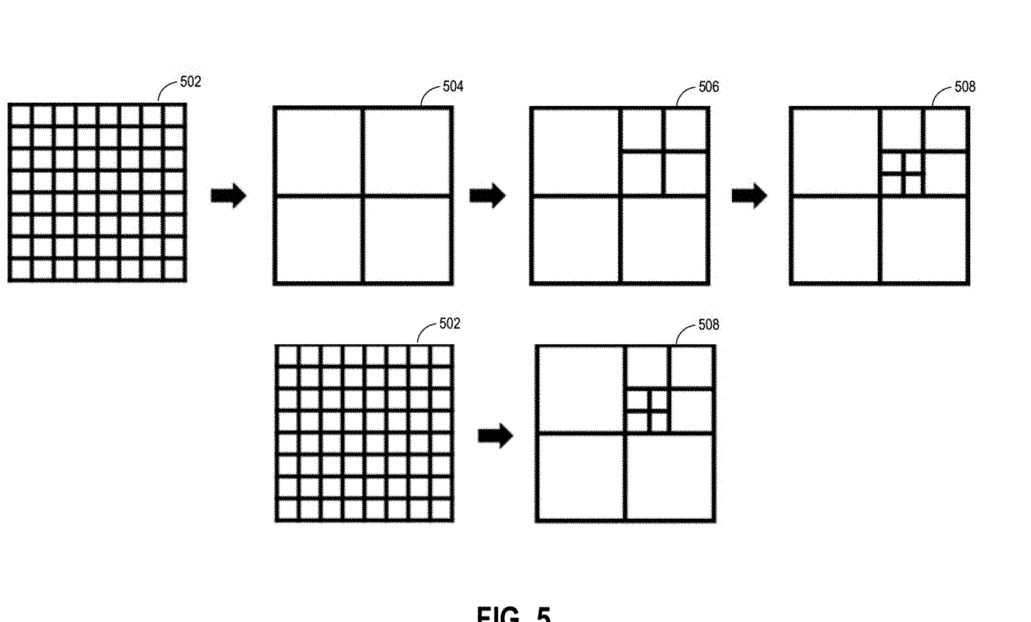

The inputs can be refined in process 408 which can then be retrained in process 410. If the current inputs contain sufficient detail (either in space and or time), (decision point 412), the obtained optimized network parameters are the final parameters for the neural network 414. If the inputs are not at the final desired detail, the inputs are once again refined, and the process repeated until the final desired resolution is achieved. Various other workflows of input refinement in both space and or time are possible. FIG. 5 shows a simple 2D example for a quadtree discretization of how the input 502 could be refined either as one step in 508 (bottom panel in FIG. 5.), or in multiple intermediate steps (for example 504 and 506) as shown in the top panel. This multi-level or multi-scale approach may improve the convergence of the optimization approach during the training process. It is understood that this general process would apply in different dimensions (including both space and time), as well as using different discretizations. The flowchart in FIG. 4 shows one embodiment of the current system, but it is to be understood that the teachings herein can be modified using other parameter optimization approaches which are common in other applied mathematics fields.

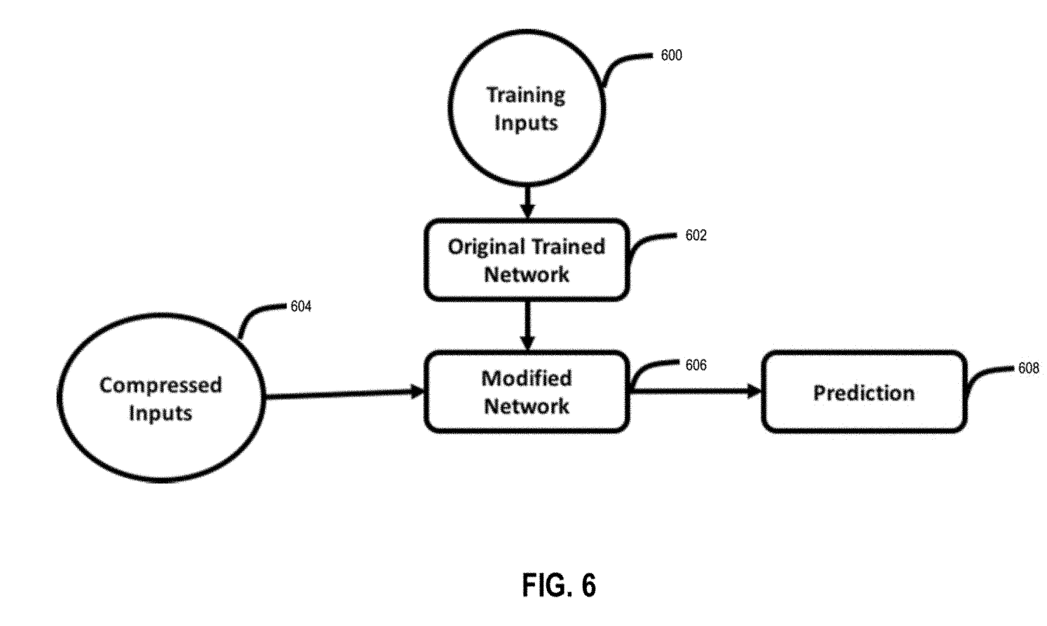

In another embodiment of the system, compression can also be applied during the prediction process. FIG. 6 shows a basic flow chart of one embodiment of this. Here inputs 600 are used to train original network parameters 602. It is desired to make predictions based on compressed inputs. The trained network can be modified using the previously described approach into modified network 606. The outputs from this network are then predictions 608. This would allow predictions to be performed on inputs (604) represented on either a different grid structure than the trained network (for example unstructured vs structured), as well as the ability to perform predictions on inputs of different compressions than the trained network. This ability may be particularly advantageous on lower power devices with less computational resources such as mobile phones. For example, consider a dataset including a compilation of 8 million videos for classification.

Many training and predicting schemes are possible with such a dataset that exploit compression and or efficient adaptive mesh representations of the inputs. Firstly, the entire dataset could be trained using traditional non-compressed representations of the videos. The trained network could then be used to classify new videos. Using this embodiment of the system, it may be possible to compress the new prediction inputs potentially speeding up the prediction process. If for example a user wanted to use the trained network on a lower power device such as a mobile phone, this compressed representation may allow predictions to be performed on less powerful computational devices. Alternatively, the original 8M videos could have been compressed or meshed adaptively during the training process. The ability to either train and or predict using compressed or efficiently represented inputs, provides flexibility depending on the hardware available and specific learning and prediction tasks. The network can either be trained using compressed or not compressed inputs, and the predictions can be performed using compressed or not compressed inputs, independent of if the system was trained using compressed inputs.

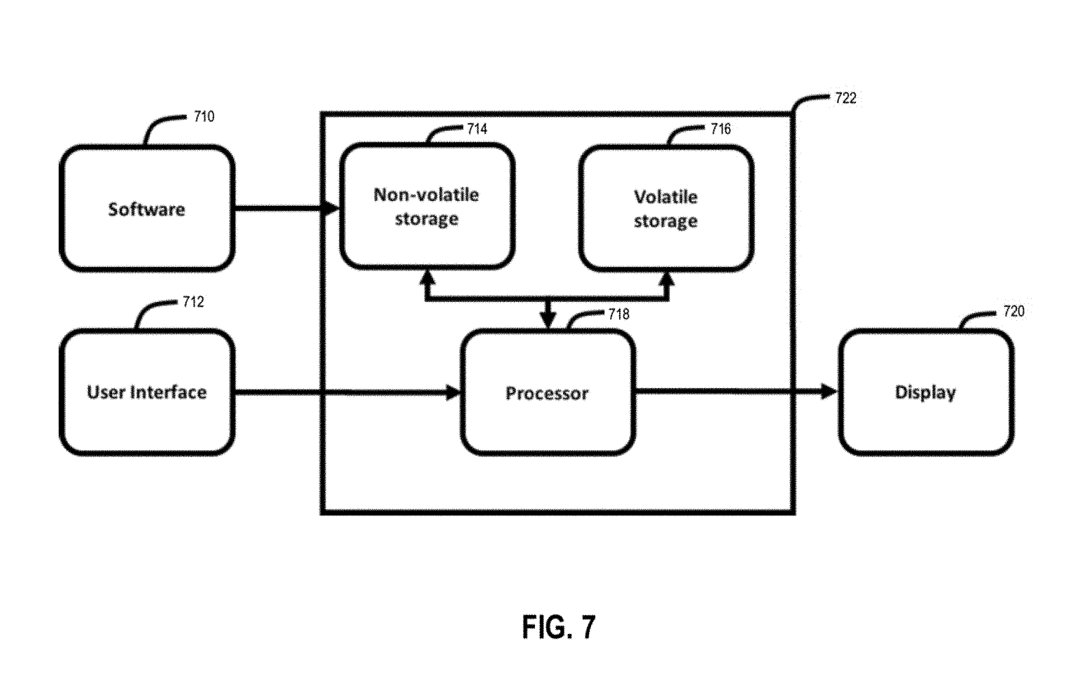

One example of a hardware platform 722 that can be used to implement the disclosed system of the preceding figures is shown in FIG. 7 and includes a Processor Unit 718 (for example a central processing unit (“CPU”), graphics processing unit (“GPU”), dedicated machine learning processor, or a combination of the above), a non-volatile storage array or device 714 and a volatile storage array or device 716. Connected to the hardware platform may include a user interface 712, and a display 720. A specific example of a suitable hardware platform is a personal computer, laptop computer or computer cluster, but the teachings herein can be modified for other presently known or future hardware platforms. The software is stored in the persistent storage 714 and runs on the Processor 710 at runtime, making use of the volatile storage 718 as needed. The system is also applicable for cloud based hardware which may involve the computations being performed on a remote server or on dynamically allocated processing resources. In such implementations, the hardware platform 722 can include a network of distributed computing devices, for example a network of servers within one or more data centers The present system is also applicable to mobile and tablet devices.

The advantages of the system and methods of FIGS. 1-7 include, without limitation, a more efficient optimization training scheme than working initially with non-compressed inputs. The convergence of the optimization problem may be improved by starting initially with coarser discretized inputs or more lossy compression, instead of working with a single input resolution. The current system allows training and predictions to be performed directly on compressed inputs such as audio files, images or videos which does not require the inputs to be uncompressed before being input into the network.

All of the tasks and steps described herein may be embodied in, and fully automated by, executable program instructions executed by a computing system comprising computing hardware that performs one or more computing tasks. Some or all of the tasks may alternatively be implemented in application-specific hardware.

The above-described system is thus capable of training neural network parameters in an efficient manner, and efficiently making predictions once trained. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiments and examples, but by all embodiments and methods within the scope and spirit of the invention.

### Overview of Example Machine Learning Training Data Augmentation

Systems and processes for augmenting training data sets will now be described with reference to FIGS. 8-10. FIG. 8 depicts a flowchart of steps for simulating training data in a machine learning system as described herein. To begin, the training process is provided with original training data at block 800. Original training data can include images, videos, audio files or other numerical datasets such as financial data, geoscience data or climate data. Block 800 is depicted with a cross-sectional image of a brain scan, for example a CT scan or magnetic resonance imaging (MRI) scan, however it will be appreciated that the disclosed training data augmentation can be used with a variety of different types of data. In some examples, original training data may be a limited data set, an unbalanced data set, or an empty data set that may benefit from augmentation with simulated data as described herein.

At block 802, the training inputs are input into a parameter estimation module that estimates the parameters of the mathematical model behind the data. If no training data is available, the estimated parameters can be created from prior knowledge of the problem which the machine learning algorithm is trying to learn. For example, domain experts such as doctors and researchers, will have an understanding of the behavior of tumor growth and the expected model parameters. Geophysicists will have a knowledge of the expected geometries and seismic velocities of salt bodies, sediments, and oil reserves. Generally, if you have a real-world phenomenon to analyze, then that would be your training data. If the system has access to a simulation available of a real world phenomenon (for example CFD simulator), that could be used to generate training data with the understanding that the machine learning model would only learn as accurately as the simulator. The parameter estimation module can estimate the parameters by solving an inverse problem or other parameter estimation technique. For example, for machine learning predictions relating to brain images (MRI, CT scan etc.), parameters of the image data which the machine learning model may be trained to estimate or classify are brain size, brain geometry, tumor geometry, tumor growth rates, brain elasticity, and the like.

Once the parameter estimation process has been performed, at block 104 the parameter estimation module can perform Monte Carlo type model parameter generation. In other examples, other probabilistic methods (e.g., Gaussian random processes) can be used in addition to or instead of Monte Carlo methods. In this step, a set of possible model parameters are populated using a probability distribution for all the variables that have inherent uncertainty. The set of models is then generated by sampling the probability functions.

This can produce a large sample of realistic model parameters, for example brain geometries and tumor growth rates in the context of training data including brain images. Additionally, other information based on domain expert knowledge can be incorporated into the data augmentation pipeline at block 806. Returning to the example of the brain imagery application, it may be known by medical experts that tumor growth rates and elastic parameters vary depending on the region of the brain and brain geometry.

At block 808, the parameter estimation module combines the models produced at both block 804 using Monte Carlo type simulations to produce a training data simulation model, as well as any at block 806 that are based on domain knowledge. To illustrate, consider the following example. For seismic examples, we have data (block 800) from which the seismic velocity of the subsurface can be estimated. Based on this estimated seismic model, the velocities of the models can be varied based on a probability density function to produce a set of N models with realistic and different seismic velocities and geometries. Additional models can be generated in block 806 based on additional information not present in the initial training data (in this seismic example, there may be drill holes with measured seismic velocity with depth, or geologic information that could be converted to seismic velocity). This additional information from the drill holes could be used to create an additional set of M models. Block 808 would append the N models generated from the original data, with the M models based on additional information into a new set of P (P≥N+M) models from which data can be simulated in block 810.

At block 810, the combined model is used to simulate training data that comports with the features defined by the training data simulation model. For example, for the brain imagery example, using the set of different brain geometries and growth rates, tumors of varying sizes and geometries can be mathematically modelled in different regions of the brain to produce a comprehensive set of possible brain images. Because the simulated data is based on the training data simulation model, which represents both the estimated parameters of the original training data as well as any problem-specific constraints leveraged from domain knowledge, the simulated data can be realistic in nature and thus usable for training a machine learning model to estimate or classify the parameters of actual training data of a similar nature.

Once the initial augmented dataset has been generated at block 810, a quality control or filtering step can be performed at block 812 to remove any unrealistic data examples from the generated dataset. This could be done in some implementations by a human, for example via a filtering user interface that presents the user with the simulated data and provides the user with selectable options to confirm or deny the simulated data. The filtering user interface can be presented to a designated user supervising the simulation of training data, for example in training scenarios in which evaluating training data requires a certain level of expertise (e.g., evaluating the realistic or unrealistic nature of a simulated brain tumor image). In other implementations, for example in training scenarios in which instances of realistic and unrealistic training data can be evaluated by a layperson, the filtering user interface may be presented to a number of different users, for example via a networked computing system. The data selected by the user(s) as unrealistic can be filtered from the training data, and the training data simulation model may be re-trained accordingly.

Additionally or alternatively, the filtering step can be performed using a machine learning algorithm such as an adversarial network. Adversarial networks are a type of unsupervised machine learning in which two models (e.g., two neural networks) compete against one another with one model being generative and the other model being discriminative. The generative model, here the simulated training data model produced at block 808, is trained to generate new potential training data inputs. The discriminative model is trained to discriminate between instances of true (real) and false (simulated) data provided to it by the generative model. During training, the generative model can have a training objective of increasing the error rate of the discriminative model (e.g., by causing the discriminative model to output “true” for simulated training data instead of real training data) and thus learns to create more realistic simulations of training data. After training of the adversarial network, the output of the discriminative model may be used to filter unrealistic simulations from the training data set.

After the unrealistic data examples have been removed at block 812, the final augmented dataset (represented by the identified realistic or true examples of training data) is stored and can be used for subsequent machine learning applications.

Many such examples exist for the above disclosed system and methods. For geophysical applications, we can invert or process geophysical data to estimate physical property models such as density, electrical conductivity, seismic velocity, magnetic susceptibility etc. The physical property models can be perturbed either stochastically, or based on some understanding of geologic processes. For example, we may want to produce a large set of physical property models with different fault events, thrusts, intrusions etc. Additionally, when searching for oil in a sub-salt environment, parameters such as salt and host geometries and the associated seismic velocities can be perturbed based on geological and petrophysical knowledge. Bore-hole and drill-hole information can also be used to construct representative physical property models. These models can be perturbed to produce another set of possible models. Data from the set of models can be generated by solving the underlying physical equations (Maxwell's equations, wave equation etc.).

For financial modelling applications, we may want to estimate parameters such as volatility, yields and returns etc., and then generate different time-series or predicted events. Once a set of realistic parameters have been obtained, the simulated data can be computed by solving the underlying equations such as the Black-Scholes equation.

For infectious disease applications, we may want to estimate and predict disease propagation and diagnosis based on transmission models. For biological applications, we may want to estimate and predict biological process such as cell growth and disease progression based on data such as blood tests and imagery. Other applications could include crowd modelling and crowd flow, as well as rumor or information propagation in social networks.

For oil and gas and mineral applications, we may want to estimate reservoir or resource properties such as grade, permeability, porosity, injection rates and capillary pressures etc. We can create different models by perturbing the reservoir properties or perturbing a known resource model. We may also want to construct models based on well-log information and other known or available information. The simulated data from fluid flow (enhanced oil recovery), steam propagation (steam assisted gravity drainage) or fracture propagation (well stimulation) can be calculated by solving the appropriate mathematical equations. Additional applications include weather and climate change data or air emissions and other industrial processes.

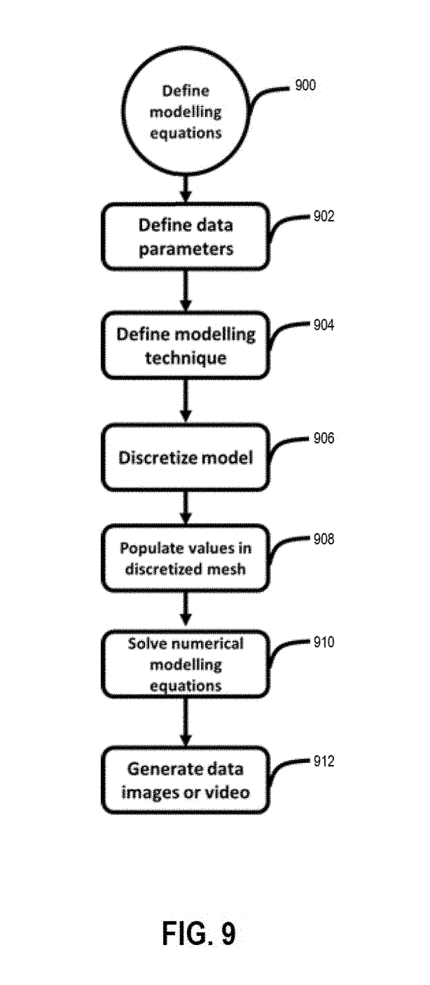

Further details of an embodiment of block 810 of FIG. 8 are shown in FIG. 9. Block 900 involves defining the appropriate modelling equations based on the machine learning problem of interest. Using the seismic example, the relevant equations may be the elastic or inelastic wave equation. Block 902 defines the parameters relevant to the simulations such as source and receiver positions, noise parameters and sampling rates etc. For the MRI example, this may include among others, imaging parameters, equipment specifications and geometry. Block 904 defines the numerical simulation technique such as finite volume, finite element, or finite volume etc. Block 906 discretizes the modelling domain (such as the earth or brain) onto a mesh (regular rectangular mesh, polygonal mesh, tetrahedral mesh, etc.) upon which the numerical simulations will be performed. Block 908 populates the cells in the discretized meshes based on the models generated from the output of block 808. Block 910 solves the numerical modelling equations using solvers such as direct linear solvers or sparse matrix solvers. Block 912 generates the augmented images or videos etc. based on the computed numerical solutions from block 910.

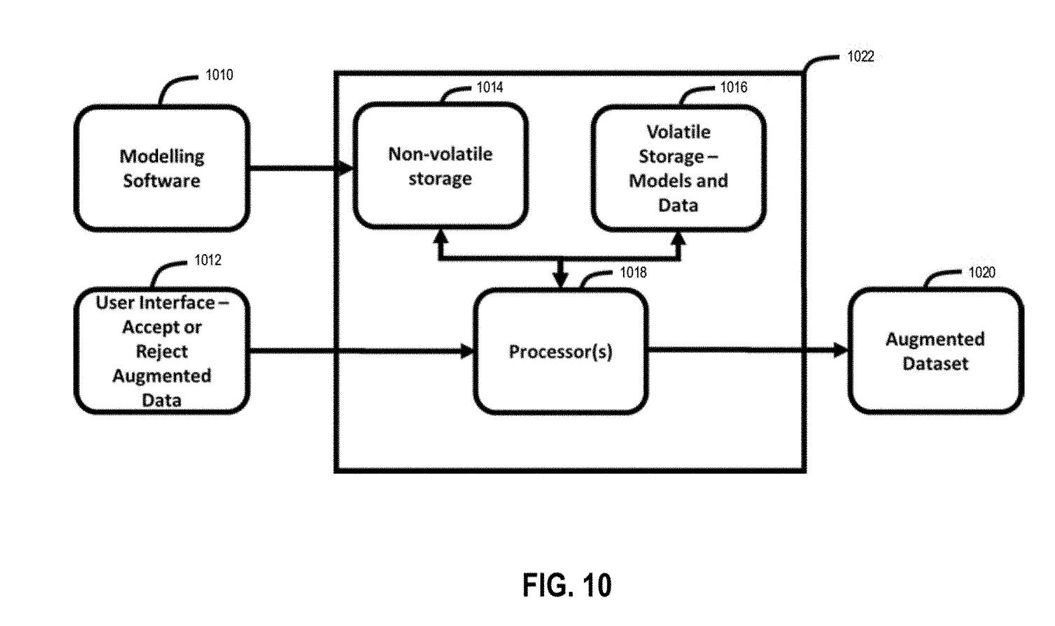

One example of a hardware platform 1022 that can be used to implement the disclosed systems and techniques of FIGS. 8 and 9 is shown in FIG. 10 and includes a processor 1018 (for example a CPU, GPU, dedicated machine learning processor, a combination of these options, or another suitable processor), a non-volatile storage 1014 and a volatile storage 1016 where the learnt parameters and augmented training data may be stored. The hardware platform may include a user interface 1012 which may allow a user to interact with the proposed augmented training data. The final augmented data set is shown in module 1020, which can be a hardware data storage device that stores the augmented training data. A specific example of a suitable hardware platform 1022 is a personal computer, laptop computer or computer cluster, but it is to be understood that the teachings herein can be modified for other presently known or future hardware platforms. The modelling software 1010 is stored in the persistent storage 1014 and runs on the processor 1018 at runtime, making use of the volatile storage 1016 as needed. The system is also applicable for cloud based hardware which may involve the computations being performed on a remote server or on dynamically allocated processing resources. In such implementations, the hardware platform 1022 can include a network of distributed computing devices, for example a network of servers within one or more data centers. The present system is also applicable to mobile and tablet devices.

Embodiments of the disclosed data simulation systems and methods allow machine learning training datasets to be created or augmented using simulations based on mathematical models of the underlying process, such that the computer-simulated training data retains a high fidelity to real-world training data. Additional information can be incorporated based on domain expertise. Augmenting the initial training datasets may improve the accuracy of the predictions from the network, for example by providing a greater range of training data that enables the trained network to generalize better to new input data than it would be able to if trained using a narrower range of training data. Beneficially, this provides for training of machine learning models to achieve a desired level of accuracy, even where the real-world data available for such training is insufficient to train the model to the desired level of accuracy.

### Overview of Example Machine Learning for File Matching

Systems and processes for training machine learning models to perform file matching will now be described with reference to FIGS. 11-13. A block diagram showing modules, inputs and outputs of one embodiment of the system is shown in FIG. 11. Input training documents and or files 1100 typically include documents such as scanned or digital PDF's of receipts and invoices or medical records. FIG. 11 depicts example inputs of paper documents to illustrate the key modules and components of the system, however it will be appreciated that the disclosed systems and techniques can operate on digitized paper documents or purely digital documents. The extract features module 1102 selects the important defining features of the documents, files or images/videos. These features are defined based on the information available in the list or any additional information that can used during the matching process. For example, if the inputs are company invoices to be matched to a list of invoices, the features of the list may include but are not limited to invoice total, invoice date, invoicing company name, invoice number, and invoice currency. If inputs 1100 include computer files, extracted features could include the file name, the file size, the date modified, and the user which modified the file. Next the parameterized similarity measure is defined in module 1104, before the parameters are learnt in process 1108 using a training list 1106 and training documents or files 1100. Once the learnt parameters 1110 have been obtained, the matching process 1112 can be performed by using the trained model on new prediction documents/files 1114 and a new prediction list 1116 to produce matched results 1118. The new prediction list is available and should have the same attributes as the training list 1106. Example applications could include matching receipts and/or invoices (either original, scanned and/or digital) to a bank statement or credit card statement, or matching medical or dental patient records with a list of patients. Other example applications could include matching many computer files to a list of files, or immigration forms to a list of people that entered the country. Further applications could include matching images/videos to a list of images/videos (for example images/videos of aerial equipment inspections with a list of items and associated information about the equipment to be inspected).

One embodiment of the system of FIG. 11 thus can be trained to perform a method for matching documents and/or files to a list.

To illustrate the system and associated methods, consider the example scenario of matching receipts to a list of credit card transactions (for example as listed on a credit card statement). Inputs 1100 are the m receipts to be matched, R={rᵢ}ᵢ₌₁^{m}, and the n items in the credit card statement, C={cᵢ}ᵢ₌₁ⁿ, 1106. A similarity measure 1104 between C and R can be parameterized by w, defined as μ(cᵢ,rⱼ|w). The parameter w can by learnt 1108 through any suitable machine learning approach, for example a structural-support vector machine (SVM), neural network or random forest etc. Finding the highest score match (which can be interpreted as the most likely match) can be formulated as solving the following linear program,

$${arg max}_{X} {\sum }_{i = 1}^{n} {\sum }_{j = 1}^{m} {x}_{i , j} \cdot μ ( {c}_{i} , {r}_{j} \vert w )$$

$$\begin{matrix} 0 \leq {x}_{i , j} \leq 1 \\ {∀}_{i} {\sum }_{j = 1}^{m} {x}_{i , j} \leq 1 \\ {∀}_{j} {\sum }_{i = 1}^{n} {x}_{i , j} \leq 1\end{matrix}$$

An X_{i,j}=1 means that the is list entry has matched the j^{th} receipt entry. A score function S, for a match X on the k-th scenario in which a set of C credit card entries is matched with R invoices, is defined as:

$${S}_{k} ( X ) = S ( X \vert {C}^{k} , {R}^{k} ) = {\sum }_{i = 1}^{n} {\sum }_{j = 1}^{m} {x}_{i , j} \cdot μ ( {c}_{i}^{k} , {r}_{j}^{k} \vert w ) .$$

Given a match X that satisfies the constraints from above, for a particular scenario k, this function provides a quality measure. The above decoding problem can be written as maximizing this S function. During training, the model learns a similarity measure μ(⋅) such that in any scenario, the correct match will have the highest score out of the alternative matches. The model is able to solve the above linear program at the evaluation time based on learning the similarity measure.

For K scenarios, with the corresponding credit card set Ĉk and receipt set R̂k, the model can be used in solving the following optimization problem (Structural-SVM):

$${arg min}_{w} \frac{1}{K} {\sum }_{k = 1}^{K} max ( 0 , {S}_{k} ( \hat{{X}^{k}} ) - {S}_{k} ( {X}^{k} ) + 1 )$$

where \hat{X}^{k} is the decoding of Sₖ(⋅), the highest scoring match with the current parameters in the k-th scenario, and, X^{k} is the correct match for the k-th scenario. A goal during model training is that the correct match will have the highest score out of all possible matches within some margin. If the parametrized similarity measure is linear in w, the above formulation is a convex optimization problem and can be solved with any gradient descent method such as stochastic gradient descent, adaptive moment estimation, or momentum. Alternatively, an objective can be used to solve for the parameterized similarity measure, where the objective penalizes the sum score of all possible matches (similar to graphical models that penalize the partition function), shown as follows.

$${arg min}_{w} \frac{1}{K} {\sum }_{k = 1}^{K} ( {\sum }_{X} {S}_{k} ( X ) ) - {S}_{k} ( {X}^{k} )$$

However, the above objective enumerates over all possible matches. The upside of this objective is that during the evaluation it also provides the probability of the match being correct, whereas in the earlier formulation the score of the best matching is output without any associated confidence value. The Structural-SVM and objective described above present two possible similarity measure functions, although other similarity measure functions are possible.

A parameterized similarity measure μ(cᵢ,rⱼ|w) can be used to assess the quality of the cᵢ and rᵢ pair. Returning to the receipt and credit card statement example, the model can split this parameterized similarity measure into three separate measures μₜ(⋅,⋅), μ_{d}(⋅,⋅), and μᵥ(⋅,⋅) for matching the total, the date, and the vendor, respectively. Splitting the parameterized similarity measure into greater or fewer measures is also possible based on the nature of the input data and list data. For this example with three unique and confident attributes (total, date, and vendor), cᵢ^{t},rⱼ^{t} is defined as the total value in i^{th} credit card entry and the total value in the j^{th} receipt entry respectively. Possible similarity measures can be defined as μₜ(cᵢ,rⱼ)=−∥cᵢ^{t}−rⱼ^{t}∥² which is equivalent to putting a Normal distribution around the credit card value. Alternatively, the model can use ft μₜ(cᵢ,rⱼ)=−∥cᵢ^{t}−rⱼ^{t}∥₁ which is equivalent to putting a Laplace distribution around the credit card value. A similar approach is suitable for dates using, for example, a UNIX-timestamp like values or an equivalent numerical representation of date.

Defining a measure for the vendor name can be a bit more complex because the vendor name that shows up on the credit card statement is usually not exactly the same as the vendor name as printed on the receipt. To resolve this, the model can define some measure such as LCS(cᵢ^{v},rⱼ^{v}) as the longest-common-subsequence between the vendor name showing up on the credit card and the vendor name we have identified in the receipt. Other measures are equally possible. The vendor similarity measure can be defined as

$${μ}_{v} ( {c}_{i} , {r}_{j} ) = \frac{LCS ( {c}_{i}^{Y} , {r}_{j}^{Y} )}{\vert {c}_{i}^{Y} \vert}$$

and then the similarity measure becomes μ(cᵢ,rⱼ|w)=w₁·μₜ(cᵢ,rⱼ)+w₂·μ_{d}(cᵢ,rⱼ)+w₃·μᵥ(cᵢ,rⱼ). In this example, the model has three parameters to learn and would most likely not need regularization. An example regularized formulation for the training objective could be

$${arg min}_{w} \frac{1}{K} {\sum }_{k = 1}^{K} max ( 0 , {S}_{k} ( \hat{{X}^{k}} ) - {S}_{k} ( {X}^{k} ) + 1 ) + \frac{λ}{2} \vert \vert w {\vert \vert}^{2}$$

which would distribute the dependency on the three measures somewhat equally. Alternatively,

$${arg min}_{w} \frac{1}{K} {\sum }_{k = 1}^{K} max ( 0 , {S}_{k} ( \hat{{X}^{k}} ) - {S}_{k} ( {X}^{k} ) + 1 ) + λ \vert \vert w {\vert \vert}_{1}$$

can be used to encourage relying only on a few measures (most likely just the total).

A more complex case exists where each receipt has a set of possible values for extracted attributes with probabilities associated with each value. For example, this situation would arise when the total, date and vendor name were automatically extracted from the receipt using a machine learning algorithm. For the attribute total, the algorithm may have identified multiple possibilities and ranked them based on the likelihood of being the correct total value. Instead of coming up with only one candidate for each field within each receipt, the model can generate a ranked list of candidates and then perform the matching between a credit card entry and the multiple entries for each extracted feature. This still uses the same μ(cᵢ,rⱼ|w) definition, but the individual measures are now defined differently. Given the probably of each possible value for the total, the first total measure can be written as an expectation

$${μ}_{t} ( {c}_{i} , {r}_{j} ) = - {\sum }_{r = 1}^{\vert {r}_{j}^{t} \vert} {ℙ}_{j}^{{t}_{r}} \cdot \vert \vert {c}_{i}^{t} - {r}_{j}^{{t}_{r}} {\vert \vert}^{2}$$

Similarly, we could define another possible measure as

$${μ}_{t} ( {c}_{i} , {r}_{j} ) = - {min}_{T} {ℙ}_{j}^{{t}_{r}} \vert \vert {c}_{i}^{t} - {r}_{j}^{{t}_{r}} {\vert \vert}^{2}$$

Probabilities can be incorporated into date and vendor name using a similar approach.

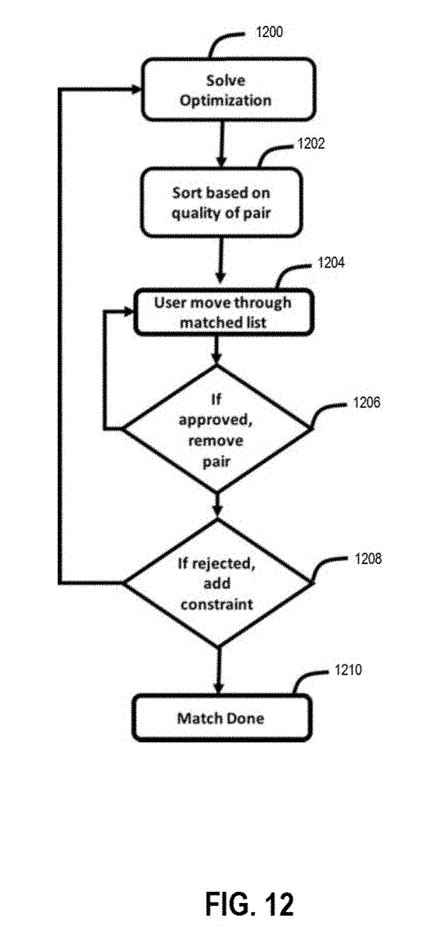

It is very likely that a human would like to check the suggested matches output from the machine learning model and ensure or confirm that they are correct. The matching process 1112 can be extended to incorporate a verification step and associated user interface as shown by the process of FIG. 12. First the recommended matching is obtained in process 1200. The matches are then sorted in order of quality of the match pair 1202, for example based on confidence values output from the model in association with the matches, such that the matches that are most likely to be correct are shown to the user first in process 1204. The user can then move through the match pairs and approve the match in process at decision point 1206. If the user confirms that the match is correct, the corresponding receipt in this example is removed from the set of possible receipts, and the corresponding entry removed from the credit card statement. This process is repeated until the user encounters a match that is incorrect. The user can then reject the match, which will then be added as a constraint to re-solve the optimization problem at block 1208. Since all the previously accepted correct matches have now been removed from the document set and corresponding list, the optimization problem should now be faster to solve. After the matching process has been updated with the new constraint, the most likely matched pairs are once again shown to the user. This process can be repeated until block 1210 at which either all the matches are correct, or the user decides to stop the process and manually match the documents with the list.

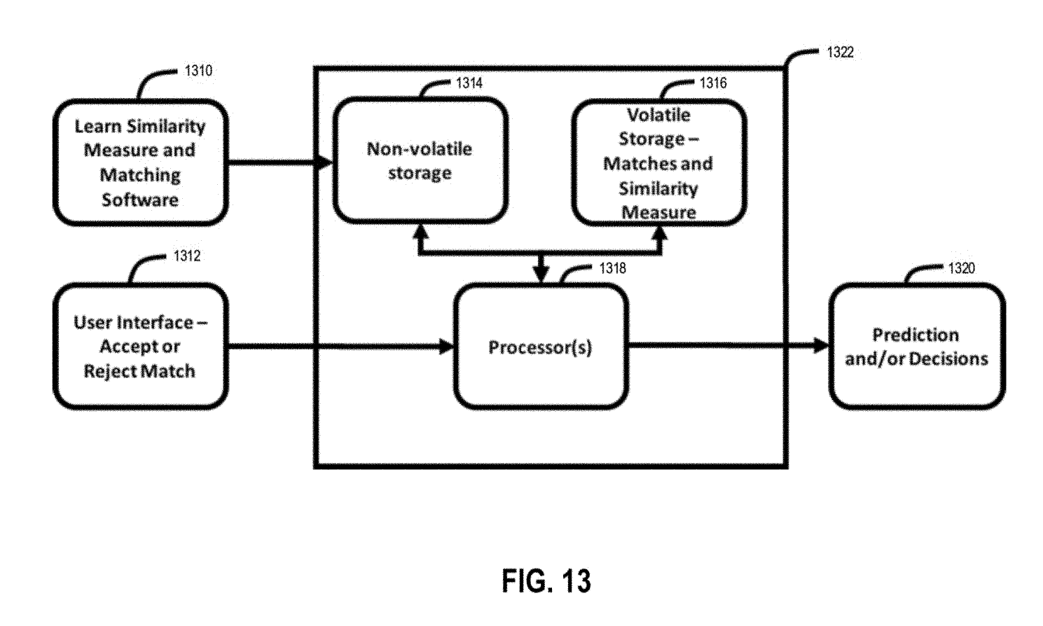

One example of a hardware platform 1322 that can be used to implement the disclosed system of FIGS. 11 and 12 is shown in FIG. 13 and includes a Processor Unit 1318 (for example a CPU, GPU, a dedicated machine learning processor, or a combination of these options), a non-volatile storage device or array 1314 and a volatile storage device or array 1316 where the learnt parameters and suggested matches may be stored. Connected to the hardware platform may include a user interface 1312 which may allow a user to select a similarity measure to be used and network architecture and parameters, as well as interact with the proposed matches. The output matches from the processor are shown in module 1320. A specific example of a suitable hardware platform is a personal computer, laptop computer or computer cluster, but it is to be understood that the teachings herein can be modified for other presently known or future hardware platforms. The learn similarity and match software 1310 is stored in the persistent storage 1314 and runs on the Processor at runtime, making use of the volatile storage as needed. The system is also applicable for cloud based hardware which may involve the computations being performed on a remote server or on dynamically allocated processing resources. In such implementations, the hardware platform 1322 can include a network of distributed computing devices, for example a network of servers within one or more data centers. The present system is also applicable to mobile and tablet devices.

The advantages of the present system include, without limitation, a robust autonomous process to match documents and or files with a list of documents and or files. The approach also allows a human to interact and add input and direction to the matching process.

The present system and methods allow for a more robust and autonomous training method to match documents or files with a list.

### Implementing Systems and Terminology

Implementations disclosed herein provide systems, methods and apparatus for training and/or using machine learning models including neural networks.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium is tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A computer-implemented process of reducing computational resources used to train a neural network to a desired level of accuracy, comprising, by execution of program instructions by a computing system:
receiving content for training the neural network, wherein the content is associated with an expected output;
generating at least first and second compressed versions of the content, wherein the first compressed version is compressed with a greater amount of lossy compression than the second compressed version;
training the neural network with the first compressed version of the content as an input, wherein training the neural network comprises tuning a set of network parameters to predict the expected output from the first compressed version of the content;
after said training, retraining the neural network with the second compressed version of the content as an input, wherein retraining the neural network comprises updating the set of network parameters to predict the expected output from the second compressed version of the content; and
storing a representation of the neural network with the updated set of network parameters for use in predicting outputs from new inputs.

2. The process of claim 1, wherein the content comprises image content, and wherein generating the first and second compressed versions comprises applying a compression algorithm to the image content.

3. The process of claim 2, wherein the image content comprises video content.

4. The process of claim 1, wherein the content comprises audio content, and wherein generating the first and second compressed versions comprises applying a compression algorithm to the audio content.

5. The process of claim 1, further comprising, after retraining the neural network with the second compressed version of the content as an input, retraining the neural network with an uncompressed version of the received content.

6. A computer-implemented process of reducing computational resources used to train a neural network to a desired level of accuracy, comprising, by execution of program instructions by a computing system:
determining a desired level of compression for input into the neural network;
accessing content for training the neural network, wherein the content is associated with an expected output;
generating at least first and second compressed versions of the content, wherein the second compressed version is compressed with a greater amount of lossy compression than the first compressed version, and wherein the second compressed version is compressed to the desired level of compression;
training the neural network with the first compressed version of the content as an input, wherein training the neural network comprises tuning a set of network parameters to predict the expected output from the first compressed version of the content;
after said training, retraining the neural network with the second compressed version of the content as an input, wherein retraining the neural network comprises updating the set of network parameters to predict the expected output from the second compressed version of the content; and
storing a representation of the neural network with the updated set of network parameters for use in predicting outputs from new inputs.

7. A computer system programmed to perform the process of claim 1.

8. Non-transitory computer storage comprising executable code that directs a computing system to perform the process of claim 1.

9. A computer system programmed to perform the process of claim 6.

10. Non-transitory computer storage comprising executable code that directs a computing system to perform the process of claim 6.
